(19) United States
(12) Patent Application Publication
(10) Pub. No.: US 2019/0154898 A1
(43) Pub. Date: May 23, 2019

(54) LAMINATE AND IMAGE DISPLAY DEVICE

(71) Applicant: NITTO DENKO CORPORATION, Osaka (JP)

(72) Inventors: Atsushi Yasui, Ibaraki-shi (JP); Yuusuke Toyama, Ibaraki-shi (JP); Shinsuke Akizuki, Ibaraki-shi (JP)

(73) Assignee: NITTO DENKO CORPORATION, Osaka (JP)

(21) Appl. No.: 16/241,286

(22) Filed: Jan. 7, 2019

Related U.S. Application Data
(62) Division of application No. 15/119,278, filed on Aug. 16, 2016.

(30) Foreign Application Priority Data
Feb. 18, 2014 (JP) 2014-028523
Feb. 16, 2015 (JP) 2015-027351

(51) Int. Cl. G02B 5/30; G02F 1/1343; B32B 7/12; G02F 1/1335

(52) U.S. Cl. CPC G02B 5/3033; G02F 1/13439; B32B 7/12; G02B 5/305; G02F 1/133528; B32B 2307/412; G02F 2202/16; B32B 2307/42; B32B 2457/20; G02F 2202/22; G02F 2202/28; B32B 2307/202

(57) ABSTRACT

Provided is a laminate including: a pressure-sensitive adhesive layer attached polarizing film including a polarizing film and a pressure-sensitive adhesive layer or layers provided on one or both sides of the polarizing film; and a transparent conductive member including a transparent conductive layer in which the transparent conductive member is bonded to the pressure-sensitive adhesive layer attached polarizing film in such a manner that the pressure-sensitive adhesive layer of the pressure-sensitive adhesive layer attached polarizing film is in contact with the transparent conductive layer of the transparent conductive member, wherein the polarizing film includes a polarizer and an inorganic layer or layers provided on one or both sides of the polarizer, and the pressure-sensitive adhesive layer is provided on at least one side of the inorganic layer of the polarizing film. Even when placed on a transparent conductive layer, the laminate can prevent degradation of the transparent conductive layer.

### CROSS-REFERENCE TO RELATED APPLICATIONS

This application is a divisional of U.S. application Ser. No. 15/119,278, filed on Aug. 16, 2016, which is a 371 of International Application No. PCT/JP2015/054197, filed on Feb. 17, 2015, which is based upon and claims the benefit of priority from the prior Japanese Patent Application No. 2015-027351, filed on Feb. 16, 2015, and Japanese Patent Application No. 2014-028523, filed on Feb. 18, 2014, the entire contents of which are incorporated herein by reference.

### TECHNICAL FIELD

The invention relates to a laminate in which a pressure-sensitive adhesive layer attached polarizing film including an inorganic layer is bonded to a member including a transparent conductive layer. The invention also relates to an image display device, such as a liquid crystal display device, an organic electroluminescence element-containing display device (organic EL display device), or a plasma display panel (PDP), including the laminate.

### BACKGROUND ART

Liquid crystal display devices and other display devices have an image-forming mechanism including polarizing elements disposed as essential components on both sides of a liquid crystal cell, in which polarizing films are usually attached as the polarizing elements. A pressure-sensitive adhesive is commonly used to bond such polarizing films to a liquid crystal cell. When such polarizing films are bonded to a liquid crystal cell, a pressure-sensitive adhesive is generally used to bond the materials together so that optical losses can be reduced. In such a case, the adhesive is provided in advance as a pressure-sensitive adhesive layer on one side of a polarizing film, and the resulting polarizing film with a pressure-sensitive adhesive layer is generally used because it has some advantages such as no need for a drying process to fix the polarizing film. In general, a release film is attached to the pressure-sensitive adhesive layer of the pressure-sensitive adhesive layer attached polarizing film.

Conventionally, a polyvinyl alcohol-based film is used to form a polarizer. Such a polarizer is hygroscopic and can easily absorb water. When absorbing a large amount of water, such a polarizer tends to have degraded performance. On the other hand, such a polarizer is used to form a polarizing film, which has a transparent protective film or films provided on one or both sides of the polarizer. In order to prevent the polarizer from absorbing water, for example, a transparent protective film with low water-vapor permeability is proposed to be used in the polarizing film. Unfortunately, in order to block water effectively, the transparent protective film with low water-vapor permeability needs to have a large thickness because its water-blocking effect depends on its thickness. In addition, when the polarizing film having the transparent protective film with low water-vapor permeability is used in the form of a pressure-sensitive adhesive layer attached polarizing film, the adhesion between the pressure-sensitive adhesive layer and the polarizing film will be insufficient.

In recent years, transparent conductive layers such as indium tin oxide (ITO) thin coatings have found a wide variety of applications. For example, it is known that a transparent conductive layer is formed as an antistatic layer on one side of the transparent substrate of a liquid crystal cell opposite to its side in contact with the liquid crystal layer in a liquid crystal display device using a liquid crystal cell of an in-plane switching (IPS) type or the like. A transparent conductive layer is also formed on a transparent resin film to form a transparent conductive film, which is used as an electrode substrate to form a touch panel. For example, such a touch panel is used in combination with a liquid crystal display device or image display device for cellular phones, portable music players, or other devices to form an input device, which has become widely spread.

Liquid crystal display devices or image display devices having such transparent conductive layers are now strongly required to be lighter and thinner. Polarizing films for use in such liquid crystal display devices and so on are also required to be lighter and thinner, and a variety of methods for manufacturing thin polarizing films have been studied.

For example, a known method of manufacturing a thin polarizing film includes forming a thin polyvinyl alcohol (PVA)-based polymer layer on a resin substrate with a certain thickness and uniaxially stretching the resulting laminate to form a thin polarizing film on the resin substrate (see, for example, Patent Document 1). Another known method of manufacturing a thin polarizing film includes forming a PVA resin layer on one surface of a base film, subjecting the resulting laminate film to free-end longitudinal uniaxial stretching at a specific stretch ratio to obtain a stretched film, and dyeing the stretched film with a dichroic dye to form a thin polarizer (see, for example, Patent Document 2).

### PRIOR ART DOCUMENTS

### Patent Documents

Patent Document 1: JP-B1-4691205
Patent Document 2: JP-B1-5048120

### SUMMARY OF THE INVENTION

### Problems to be Solved by the Invention

When a transparent conductive layer is used as an antistatic layer, a pressure-sensitive adhesive layer attached polarizing film is placed on a liquid crystal cell including the antistatic layer, and the antistatic layer made of a transparent conductive layer is bonded to the polarizing film with the pressure-sensitive adhesive layer interposed therebetween. When a transparent conductive layer is used as a touch panel electrode, some types of touch panels have a structure in which a pressure-sensitive adhesive layer attached polarizing film is placed on the electrode-forming transparent conductive layer, and an antistatic layer made of a transparent conductive layer is bonded to the polarizing film with the pressure-sensitive adhesive layer interposed therebetween.

Thin polarizing films obtained according to Patent Documents 1 and 2 are all one-side-protected polarizing films in which one side of the polarizer is protected by a transparent protective film. When such a polarizing film is bonded to a liquid crystal cell including a transparent conductive layer, the polarizer is bonded to the transparent conductive layer with a pressure-sensitive adhesive interposed therebetween. It has been found that when a transparent conductive layer is bonded to the polarizer surface of a one-side-protected iodine-based polarizer with a pressure-sensitive adhesive layer interposed therebetween, a small amount of iodine can leach from the iodine-based polarizer into the pressure-sensitive adhesive layer to reach and degrade (corrode) the transparent conductive layer. If the transparent conductive layer used, for example, as an antistatic layer is degraded, static electricity-induced unevenness can occur in a liquid crystal panel, and the antistatic performance can decrease. When a transparent conductive layer is used as a touch panel electrode, the degradation of the electrode can cause various problems such as an increase in electric resistance, a malfunction such as faulty sensing, and a reduction in touch panel sensitivity.

Techniques of making thinner polarizing films also include techniques of using a thinner transparent protective film or films, in addition to the techniques described in Patent Documents 1 and 2, such as the technique of reducing the thickness of a polarizer itself and the technique of placing a transparent protective film on only one side of a polarizer. Even in a double-side-protected polarizing film including a polarizer and transparent protective films provided on both sides of the polarizer, the phenomenon of the leaching of iodine from an iodine-based polarizer into a pressure-sensitive adhesive can occur to degrade a transparent conductive layer when a thinner transparent protective film is used as mentioned above. It has been found that this phenomenon is more likely to occur particularly when a thinner transparent protective film with higher water-vapor permeability is used.

It is therefore an object of the invention to provide a laminate that includes a pressure-sensitive adhesive layer attached polarizing film and a member including a transparent conductive layer bonded together and can prevent the transparent conductive layer from being degraded even when the polarizing film is placed on the transparent conductive layer.

It is another object of the invention to provide an image display device including such a laminate.

### Means for Solving the Problems

As a result of intensive studies to solve the problems, the inventors have found the laminate described below and thus completed the invention.

Specifically, the invention is directed to a laminate including: a pressure-sensitive adhesive layer attached polarizing film including a polarizing film and a pressure-sensitive adhesive layer or layers provided on one or both sides of the polarizing film; and a transparent conductive member including a transparent conductive layer in which the transparent conductive layer bonded to the pressure-sensitive adhesive layer attached polarizing film in such a manner that the pressure-sensitive adhesive layer of the pressure-sensitive adhesive layer attached polarizing film is in contact with the transparent conductive layer of the transparent conductive member, wherein the polarizing film includes a polarizer and an inorganic layer or layers provided on one or both sides of the polarizer, and the pressure-sensitive adhesive layer is provided on at least one side of the inorganic layer of the polarizing film. The polarizing film may have a transparent protective film or films provided on one or both sides of the polarizer with or without the inorganic layer interposed therebetween. When a transparent protective film is provided, the inorganic layer on at least one side is preferably an outermost layer.

In the laminate, the polarizing film may have a first transparent protective film provided on a first side of the polarizer with no inorganic layer interposed therebetween, and the inorganic layer may be provided on only a second side of the polarizer. The polarizing film may further include a second transparent protective film, and the inorganic layer may be provided on the second side of the polarizer with the second transparent protective film interposed therebetween.

In the laminate, the inorganic layer preferably includes an inorganic oxide or an inorganic nitride. In addition, the inorganic layer preferably includes at least one selected from silicon oxide, silicon nitride, and aluminum oxide.

In the laminate, the polarizer preferably has a thickness of 10 μm or less.

In the laminate, the polarizing film preferably has a single transmittance of 30% or more and a degree of polarization of 90% or more.

In the laminate, the pressure-sensitive adhesive layer attached polarizing film preferably has such a structure that the pressure-sensitive adhesive layer is placed directly on the inorganic layer, and the pressure-sensitive adhesive layer preferably has an adhesive strength of 15 N/25 mm or more, more preferably 20 N/25 mm or more, to the inorganic layer.

In the laminate, the pressure-sensitive adhesive layer is preferably made from an acrylic pressure-sensitive adhesive including a (meth)acryl-based polymer as a base polymer.

In the laminate, the acrylic pressure-sensitive adhesive preferably further contains a coupling agent. The coupling agent is preferably at least one selected from the group consisting of a silane coupling agent, a zirconium coupling agent, and a titanate coupling agent. The content of the coupling agent is preferably from 0.001 to 5 parts by weight based on 100 parts by weight of the (meth)acryl-based polymer.

In the laminate, the acrylic pressure-sensitive adhesive may further contain a crosslinking agent.

In the laminate, the pressure-sensitive adhesive layer attached polarizing film preferably has a water-vapor permeability of 0.000001 g/m²·day or more and 5 g/m²·day or less as measured at 40° C. and 90% RH.

In the laminate, the transparent conductive layer preferably includes an indium tin oxide. The indium tin oxide may be amorphous indium thin oxide.

The laminate preferably shows a rate of resistance change of 130% or less, wherein the rate of resistance change is a rate of change in the resistance of the transparent conductive layer between before and after storage of the laminate for 500 hours in an environment at 60° C. and 90% RH (between the initial resistance and the resistance after heating and humidification) and calculated from the formula:

Rate of resistance change={(the resistance after heating and humidification)/(the initial resistance)}×100.

The invention is also directed to an image display device including the laminate.

In the image display device, the transparent conductive member including a transparent conductive layer may be a member including a transparent conductive layer and a liquid crystal cell.

In the image display device, the transparent conductive member including a transparent conductive layer may be a transparent conductive film including the transparent conductive layer, and the laminate may be used to form a touch panel.

### Effect of the Invention

It has been found that iodine-induced degradation of a transparent conductive layer becomes more likely to occur as the water content of the pressure-sensitive adhesive layer to be in contact with the transparent conductive layer increases. In the laminate of the invention including a structure in which the transparent conductive layer is placed on the pressure-sensitive adhesive layer of the pressure-sensitive adhesive layer attached polarizing film, the polarizing film of the pressure-sensitive adhesive layer attached polarizing film has an inorganic layer or layers provided on one or both sides of the polarizer. The polarizing film of the pressure-sensitive adhesive layer attached polarizing film may have a transparent protective film provided on the polarizer with or without the inorganic layer interposed therebetween. The inorganic layer can keep the water content of the pressure-sensitive adhesive layer at a low level and has iodine barrier properties, which makes it possible to prevent degradation of the transparent conductive layer in the laminate.

In the laminate of the invention, as stated above, the polarizing film used to form the pressure-sensitive adhesive layer attached polarizing film may have the inorganic layer directly on the polarizer or may have the inorganic layer on the polarizer with a transparent protective film interposed therebetween. In the laminate of the invention, therefore, the polarizer is effectively blocked from absorbing water vapor due to the presence of the inorganic layer. Even a thin inorganic layer can effectively block water whereas a transparent protective film with low water-vapor permeability needs to be thick in order to block water effectively. Modules for liquid crystal display devices and other devices are required to be thin, and thus polarizing films are also required to be thin. In the polarizing film according to the invention, the inorganic layer can effectively block water and keep the polarizing film thin. When the inorganic layer is formed directly on the polarizer, it is possible to use the polarizing film without any transparent protective film provided on the side where the inorganic layer is formed. In the laminate of the invention, the polarizing film used to form the pressure-sensitive adhesive layer attached polarizing film may have the inorganic layer formed directly on the polarizer, in which the inorganic layer can effectively block water and iodine and keep the polarizing film thin.

In the laminate of the invention, a thin polarizer is effectively used to form the polarizing film of the pressure-sensitive adhesive layer attached polarizing film. A thin polarizer, which is a thin coating, is more resistant to shrinkage than a normal polarizer. Therefore, shrinkage-induced damage to the inorganic layer is smaller when the inorganic layer is provided on a thin polarizer than when it is provided on a normal polarizer. A thin polarizer, which is thinner than a normal polarizer, is also preferred in order to block water because the amount of water vapor entering the inside from the cross-section is relatively small. The polarizing film according to the invention has substantially the same optical properties as an inorganic layer-free polarizing film and also has good optical properties even when placed in a harsh environment.

In the laminate of the invention, the pressure-sensitive adhesive layer attached polarizing film has the pressure-sensitive adhesive layer placed on the inorganic barrier layer of the polarizing film, in which the inorganic barrier layer has good adhesion to the pressure-sensitive adhesive layer. Therefore, the pressure-sensitive adhesive layer attached polarizing film is provided in a preferred manner.

### BRIEF DESCRIPTION OF THE DRAWINGS

FIG. 1 is a cross-sectional view illustrating an example of the laminate of the invention.

FIGS. 2(a) and 2(b) are cross-sectional views illustrating examples of the polarizing film for use in the laminate of the invention.

FIGS. 3(a1) and 3(a2) are cross-sectional views illustrating examples of the polarizing film for use in the laminate of the invention.

FIGS. 4(a1) and 4(a2) are cross-sectional views each illustrating a pressure-sensitive adhesive layer attached polarizing film for use in the laminate of the invention.

FIG. 5 is a cross-sectional view schematically illustrating an embodiment of the image display device of the invention.

FIG. 6 is a cross-sectional view schematically illustrating an embodiment of the image display device of the invention.

FIG. 7 is a cross-sectional view schematically illustrating an embodiment of the image display device of the invention.

FIG. 8 is an electron micrograph showing an inorganic layer in a polarizing film including an inorganic layer obtained in Example 1.

### MODE FOR CARRYING OUT THE INVENTION

Hereinafter, embodiments of the laminate of the invention will be described in detail with reference to the drawings. It will be understood that the embodiments shown in the drawings are not intended to limit the invention.

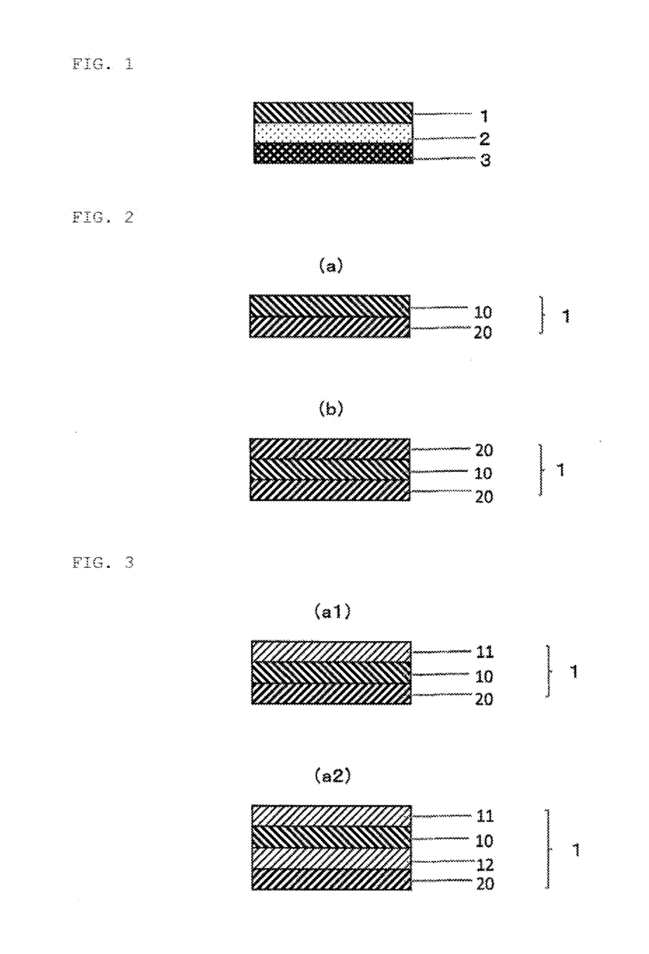

As shown in FIG. 1, the laminate of the invention has a structure in which a pressure-sensitive adhesive layer attached polarizing film including a polarizing film 1 and a pressure-sensitive adhesive layer 2 and a transparent conductive member including a transparent conductive layer 3 are bonded together in such a manner that the pressure-sensitive adhesive layer 2 is in contact with the transparent conductive layer 3 of the transparent conductive member. FIG. 1 shows a case where the pressure-sensitive adhesive layer 2 is provided on one side of the polarizing film 1. Alternatively, the pressure-sensitive adhesive layers 2 may be provided on both sides of the polarizing film. It should be noted that FIG. 1 shows only the transparent conductive layer 3 of the transparent conductive member.

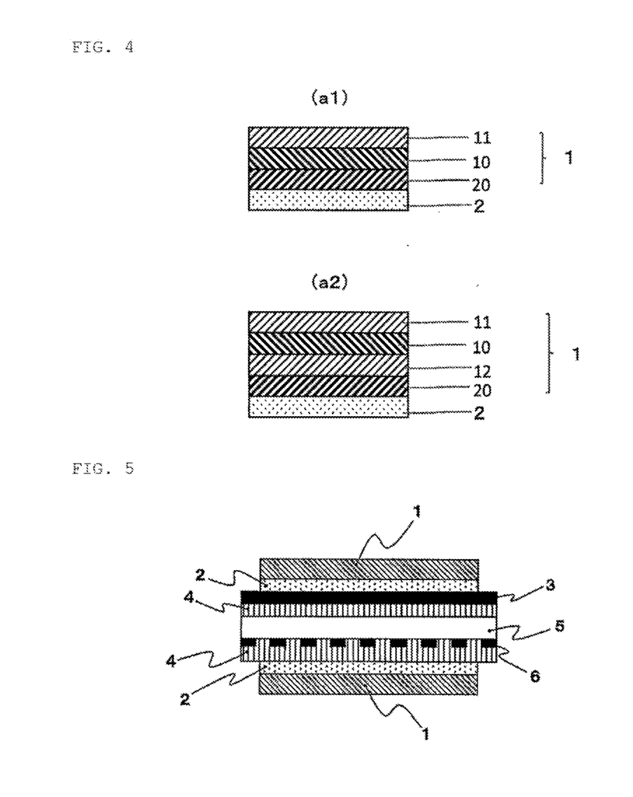

In the invention, as shown in FIGS. 2(a) and 2(b), the polarizing film 1 includes a polarizer 10 and an inorganic layer or layers 20 on one or both sides (one or both of first and second sides) of the polarizer 10. The first and second sides of the polarizer may be defined interchangeably. FIG. 2(a) shows a case where the inorganic layer 20 is provided directly on only the first side of the polarizer 10. FIG. 2(b) shows a case where the inorganic layers 20 are provided directly on both sides of the polarizer 10.

In the invention, the polarizing film may include a transparent protective film or films provided one or both sides of the polarizing film shown in FIG. 2(a) or 2(b). The transparent protective film may be provided on the polarizer with or without the inorganic layer interposed therebetween. In a preferred mode, the inorganic layer on at least one side is an outermost layer. The outermost inorganic layer may be bonded to the pressure-sensitive adhesive layer. FIG. 3(a1) and FIG. 3(a2) show cases where a transparent protective film is provided on the polarizing film of FIG. 2(a). FIG. 3(a1) shows a case where a first transparent protective film 11 is provided on the first side of the polarizer 10 while the inorganic layer 20 is provided directly on the second side (the side opposite to the first side) of the polarizer 10. FIG. 3(a2) shows a case where a first transparent protective film 11 is provided on the first side of the polarizer 10 while the inorganic layer 20 is provided on the second side of the polarizer 10 with a second transparent protective film 12 interposed therebetween.

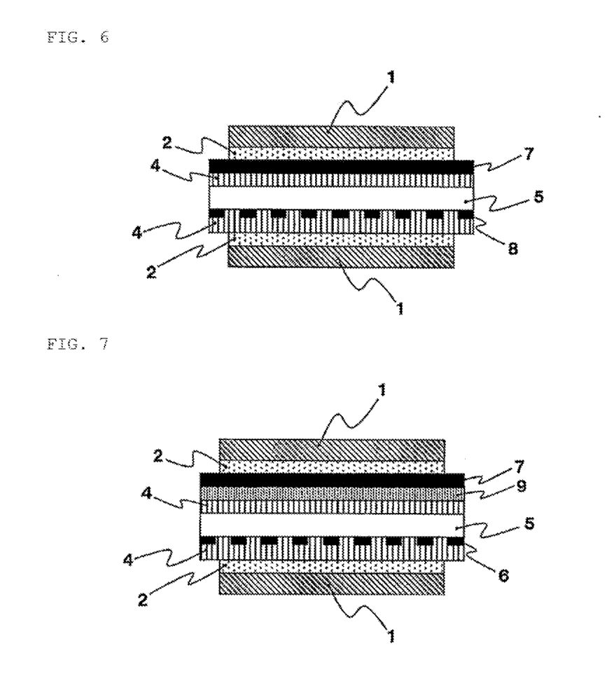

In the invention, a pressure-sensitive adhesive layer may be provided on the inorganic layer of the polarizing film. FIGS. 4(a1) and 4(a2) show pressure-sensitive adhesive layer attached polarizing films according to the invention, in which a pressure-sensitive adhesive layer 2 is provided on the inorganic layer 20 of the polarizing films of FIGS. 3(a1) and 3(a2), respectively.

FIG. 3 shows a case where the polarizing film of FIG. 2(a) is provided with a transparent protective film or films, and FIG. 4 shows a case where the polarizing film of FIG. 3 is provided with a pressure-sensitive adhesive layer. It will be understood that the polarizing film of FIG. 2(b) may also be provided with a first transparent protective film and/or a second transparent protective film with or without the inorganic layer interposed therebetween, in which a pressure-sensitive adhesive layer may also be provided on the inorganic layer. A pressure-sensitive adhesive layer may also be provided on the inorganic layer of the polarizing film of FIG. 2(a) or 2(b).

In the invention, the pressure-sensitive adhesive layer attached polarizing film has an inorganic layer, which allows the water-vapor permeability of the polarizing film to be controlled to a low level. The water-vapor permeability is preferably 0.01 g/m²·day or more and 5 g/m²·day or less as measured at 40° C. and 90% RH. The water-vapor permeability is preferably 0.0000001 g/m²·day or more as measured at 40° C. and 90% RH because in this case, the inorganic layer can be formed with a thickness of 1,000 μm or less without involving a significant increase in thickness. The water-vapor permeability is preferably 5 g/m²·day or less because in this case, water vapor can be effectively blocked. All of the polarizing film and the pressure-sensitive adhesive layer attached polarizing film preferably have a water-vapor permeability of 0.000001 or more and 5 g/m²·day or less, more preferably 0.0001 or more and 1 g/m²·day or less.

<Polarizer>

Any of various polarizers may be used without restriction. For example, the polarizer may be a product produced by a process including adsorbing a dichroic material such as iodine or a dichroic dye to a hydrophilic polymer film such as a polyvinyl alcohol-based film, a partially-formalized polyvinyl alcohol-based film, or a partially-saponified, ethylene-vinyl acetate copolymer-based film and uniaxially stretching the film or may be a polyene-based oriented film such as a film of a dehydration product of polyvinyl alcohol or a dehydrochlorination product of polyvinyl chloride. Among these polarizers, the use of a polarizer including a polyvinyl alcohol-based film and a dichroic material such as iodine makes the effect of the invention more remarkable. The thickness of these polarizers is generally, but not limited to, about 80 μm or less. In general, the thickness of the polarizer is preferably from 15 to 35 μm.

For example, a polarizer including a uniaxially-stretched polyvinyl alcohol-based film dyed with iodine can be produced by a process including immersing a polyvinyl alcohol film in an aqueous iodine solution to dye the film and stretching the film to 3 to 7 times the original length. If necessary, the film may also be immersed in an aqueous solution of boric acid, potassium iodide, or the like. If necessary, the polyvinyl alcohol-based film may be further immersed in water for washing before it is dyed. When the polyvinyl alcohol-based film is washed with water, dirt and any anti-blocking agent can be cleaned from the surface of the polyvinyl alcohol-based film, and the polyvinyl alcohol-based film can also be allowed to swell so that unevenness such as uneven dyeing can be effectively prevented. The film may be stretched before, while, or after it is dyed with iodine. The film may also be stretched in an aqueous solution of boric acid, potassium iodide, or the like or in a water bath.

A thin polarizer with a thickness of 10 μm or less may also be used. In view of thickness reduction, the thickness is preferably from 1 to 7 μm. Such a thin polarizer is less uneven in thickness, provides good visibility, and is less dimensionally-variable, and thus has high durability. It is also preferred because it can form a thinner polarizing film.

When the inorganic layer is formed directly on the polarizer by sputtering as described below, the polarizer preferably has a relatively low water content in view of sputtering efficiency. From this point of view, the polarizer preferably has a water content of 20% or less, more preferably 15% or less, even more preferably 5% or less. On the other hand, the polarizer preferably has a water content of 0.5% or more. A lower water content may require a longer drying time, which may significantly reduce productivity.

The water content of the polarizer may be controlled by any appropriate method. For example, the water content of the polarizer may be controlled by a method of controlling conditions in the drying step of the polarizer manufacturing process.

The water content of the polarizer can be measured by the following method. Specifically, a sample with a size of 100×100 mm is cut from the polarizer and measured for initial weight. Subsequently, the sample is dried at 120° C. for 2 hours and then measured for dry weight. The water content is determined from the following formula: water content (% by weight)={(the initial weight−the dry weight)/(the initial weight)}×100. Each measurement of the weight is performed three times, and the average of the measurements is used.

Like the water content, the water content per unit area of the polarizer is preferably relatively low when the inorganic layer is formed. The relatively low water content per unit area is preferable, for example, for sputtering efficiency. From these points of view, the polarizer preferably has a water content per unit area of 3 g/m² or less, more preferably 2 g/m² or less, even more preferably 1 g/m² or less. On the other hand, the polarizer preferably has a water content per unit area of 0.05 g/m² or more. A lower water content per unit area may require a longer drying time, which may significantly reduce productivity.

The water content per unit area of the polarizer may be controlled by any appropriate method. Examples include controlling the water content of the polarizer to a relatively low level, reducing the thickness of the polarizer, and reducing the water content of the polarizer and the thickness of the polarizer.

The water content per unit area of the polarizer can be measured by the following method. Specifically, a sample with a size of 100 mm×100 mm is cut from the polarizer and measured for initial weight. Subsequently, the sample is dried at 120° C. for 2 hours and then measured for dry weight. The water content is determined from the following formula: water content (g/m²)=(the initial weight−the dry weight)×100. Each measurement of the weight is performed three times, and the average of the measurements is used.

Typical examples of the thin polarizer include the thin polarizing films described in JP-A-51-069644, JP-A-2000-338329, WO2010/100917, PCT/JP2010/001460, Japanese Patent Application No. 2010-269002, and Japanese Patent Application No. 2010-263692. These thin polarizing films can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage by stretching, because the layer is supported on the stretchable resin substrate.

<Transparent Protective Film>

The transparent protective film is preferably made of a material having a high level of transparency, mechanical strength, thermal stability, water barrier properties, isotropy, and other properties. Examples of such a material include polyester polymers such as polyethylene terephthalate and polyethylene naphthalate, cellulose polymers such as diacetyl cellulose and triacetyl cellulose, acryl-based polymers such as polymethylmethacrylate, styrene polymers such as polystyrene and acrylonitrile-styrene copolymers (AS resins), and polycarbonate polymers. Examples of polymers that may be used to form the transparent protective film also include polyolefin polymers such as polyethylene, polypropylene, cyclo- or norbornene-structure-containing polyolefin, and ethylene-propylene copolymers, vinyl chloride polymers, amide polymers such as nylon and aromatic polyamide, imide polymers, sulfone polymers, polyether sulfone polymers, polyether ether ketone polymers, polyphenylene sulfide polymers, vinyl alcohol polymers, vinylidene chloride polymers, vinyl butyral polymers, arylate polymers, polyoxymethylene polymers, epoxy polymers, or any blends of the above polymers. The transparent protective film may also contain any type of one or more appropriate additives. Examples of such additives include ultraviolet absorbers, antioxidants, lubricants, plasticizers, release agents, discoloration preventing agents, flame retardants, nucleating agents, antistatic agents, pigments, and colorants. The content of the thermoplastic resin in the transparent protective film is preferably 50 to 100% by weight, more preferably 50 to 99% by weight, even more preferably 60 to 98% by weight, further more preferably 70 to 97% by weight. If the content of the thermoplastic resin in the transparent protective film is 50% by weight or less, high transparency and other properties inherent in the thermoplastic resin may fail to be sufficiently exhibited.

A low-water-vapor-permeability film with a water-vapor permeability of 150 g/m²/24 hours or less may be used as the transparent protective film. In particular, the low-water-vapor-permeability film is preferably used as the second transparent protective film. This feature makes the polarizing film resistant to the entry of water from the air and also prevents the polarizing film from changing in water content. As a result, storage environment-induced curing or dimensional changes of the polarizing film can be suppressed.

The transparent protective film or films provided on one or both sides of the polarizer are preferably made of a material having a high level of transparency, mechanical strength, thermal stability, water barrier properties, isotropy, and other properties. In particular, the transparent protective film or films are preferably made of a material with a water-vapor permeability of 150 g/m·day or less, more preferably 140 g/m·day or less, even more preferably 120 g/m·day or less. The water-vapor permeability can be determined by the method described below.

<Water-Vapor Permeability of Transparent Protective Film>

The water-vapor permeability (g/m·day) of the transparent protective film is determined by measurement in the atmosphere at 40° C. and 90% R.H. for 24 hours using PERMATRAN-W manufactured by MOCON Inc.

Examples of materials that may be used to form the transparent protective film with a satisfactorily low level of water-vapor permeability as mentioned above include polyester resins such as polyethylene terephthalate and polyethylene naphthalate, polycarbonate resins, arylate resins, amide resins such as nylon and aromatic polyamide, polyolefin polymers such as polyethylene, polypropylene, and ethylene-propylene copolymers, cyclic olefin-based resins having a cyclo-structure or a norbornene structure, (meth)acrylic resins, or any blends thereof. Among these resins, polycarbonate resins, cyclic polyolefin resins, and (meth)acrylic resins are preferred, and cyclic polyolefin resins and (meth)acrylic resins are particularly preferred.

The thickness of the transparent protective film may be selected as appropriate. The transparent protective film generally has a thickness of about 1 to about 100 μm in view of strength, workability such as handleability, thin layer formability, and other properties. In particular, the thickness of the transparent protective film is preferably from 1 to 80 μm, more preferably from 3 to 60 μm.

When the transparent protective films are provided on both sides of the polarizer, the transparent protective films used on the front and back sides may be made of the same polymer material or different polymer materials.

The surface of the first transparent protective film, opposite to its surface where the polarizer is to be bonded, may be provided with a functional layer such as a hard coat layer, an anti-reflection layer, an anti-sticking layer, a diffusion layer, or an antiglare layer. The functional layer such as a hard coat layer, an anti-reflection layer, an anti-sticking layer, a diffusion layer, or an antiglare layer may be provided as part of the transparent protective film itself or as a layer independent of the transparent protective film.

The polarizer and the first or second transparent protective film may be bonded together with an adhesive. Examples of such an adhesive include isocyanate-based adhesives, polyvinyl alcohol-based adhesives, gelatin-based adhesives, vinyl adhesives, latex-based adhesives, and aqueous polyester adhesives. The adhesive is generally used in the form of an aqueous adhesive solution, which generally has a solid content of 0.5 to 60% by weight. Besides the above, ultraviolet-curable adhesives, electron beam-curable adhesives, or the like may also be used to bond the polarizer and the transparent protective film together. Electron beam-curable adhesives for use on polarizing films have good adhesion to the various transparent protective films described above. The adhesive for use in the invention may also contain a metal compound filler.

<Inorganic Layer>

The inorganic layer includes an inorganic material having a water vapor barrier function. The inorganic layer may be made of, for example, an inorganic oxide or an inorganic nitride. In the invention, the inorganic layer does not need to be conductive and may be non-conductive in contrast to the transparent conductive layer of the transparent conductive film described below. In general, a non-conductive layer with a surface resistance of 1.0×10¹³Ω/□ or more may be used as the inorganic layer. The surface resistance may be measured by the resistance measurement method described for the corrosion resistance test in the EXAMPLES section. The inorganic layer can be formed, for example, by physical vapor deposition or chemical vapor deposition of an inorganic oxide or an inorganic nitride on the surface of the polarizer or the transparent protective film. The inorganic oxide or the inorganic nitride may be, for example, an oxide or a nitride of silicon (Si), aluminum (Al), magnesium (Mg), calcium (Ca), potassium (K), sodium (Na), boron (B), lead (Pb), zirconium (Zr), yttrium (Y), or other metals. Among these inorganic oxides and inorganic nitrides, silicon oxide, silicon nitride, and aluminum oxide are preferred, which have a high level of transparency and water vapor barrier properties. One or more selected from the group consisting of these materials are preferably used. Among them, silicon oxide is particularly preferred, having good properties such as water vapor barrier properties, transparency, flexibility, and adhesion. The inorganic oxide can be expressed as MOₓ, (M represents a metal element, and x represents the degree of oxidation), such as SiOₓ or AlOₓ. In view of gas barrier properties and transparency, the degree of oxidation x is preferably in the range of 1.3 to 1.9 when M is silicon (Si), and preferably in the range of 0.5 to 1.5 when M is aluminum (Al).

The physical vapor deposition (PVD) may be, for example, vacuum deposition, sputtering, ion plating, or ion cluster beam deposition. More specifically, a vapor-deposited film of a metal oxide can be formed using (a) a vacuum deposition method including heating a metal oxide as a raw material to form a vapor of the metal oxide and depositing the metal oxide on the surface of the object (the surface of the polarizer or the transparent protective film) from the vapor, (b) a reactive vapor deposition method including using a metal or a metal oxide as a raw material, optionally introducing oxygen gas or other gases to oxidize the raw material, and vapor-depositing the metal oxide on the surface of the object, or (c) a plasma-assisted reactive vapor deposition method in which the reaction such as oxidation is further assisted with plasma. The material to be vapor-deposited can be heated by, for example, resistance heating, high frequency induction heating, electron beam heating (EB), or other heating methods. Among the above physical vapor deposition methods, sputtering is preferred, in which an inorganic oxide or an inorganic nitride can be easily vaporized.

The chemical vapor deposition (CVD) may be, for example, plasma chemical vapor deposition, thermo-chemical vapor deposition, or photochemical vapor deposition. In particular, the chemical vapor deposition is preferably plasma CVD, in which the inorganic layer can be formed at relatively low temperatures. More specifically, the plasma CVD may be a method that includes using a monomer gas such as an organosilicon compound as a raw material for vapor deposition, using an inert gas such as argon or helium as a carrier gas, supplying an oxygen gas, an ammonia gas, or an additional gas, and subjecting the gases to a chemical reaction using a low-temperature plasma generator or the like so that a vapor-deposited thin film of an inorganic oxide such as silicon oxide or an inorganic nitride is formed on the surface of the object (the surface of the polarizer or the transparent protective film). The low-temperature plasma generator may be, for example, a high-frequency plasma generator, a pulse wave plasma generator, or a microwave plasma generator. In particular, a high-frequency plasma generator is preferred, in which highly active stable plasma can be obtained.

Examples of the monomer gas, such as the organosilicon compound, which may be used to forma vapor-deposited thin film of an inorganic oxide such as silicon oxide, include 1,1,3,3-tetramethyldisiloxane, hexamethyldisiloxane, vinyltrimethylsilane, methyltrimethylsilane, hexamethyldisilane, methylsilane, dimethylsilane, trimethylsilane, diethylsilane, propylsilane, phenylsilane, vinyltriethoxysilane, vinyltrimethoxysilane, tetramethoxysilane, tetraethoxysilane, phenyltrimethoxysilane, methyltriethoxysilane, and octamethylcyclotetrasiloxane. Among these monomer gases for vapor deposition, 1,1,3,3-tetramethyldisiloxane and hexamethyldisiloxane are preferred, which have good handleability and provide good physical properties for the vapor-deposited film.

The inorganic layer may be a monolayer structure or a multilayer structure including two or more sublayers. When the inorganic layer has such a multilayer structure, the thermal load can be reduced during the vapor deposition, which makes it possible to reduce the degradation of the polarizer or the transparent protective film and to improve the adhesion and other properties between the pressure-sensitive adhesive layer and the inorganic layer. The conditions for the physical vapor deposition and the chemical vapor deposition may be designed as appropriate depending on the type of the polarizer or the transparent protective film, the thickness of the inorganic layer, and other factors.

The inorganic layer preferably has a thickness (average thickness) of about 1 nm to about 1,000 nm. The thickness (average thickness) of the inorganic layer may have a lower limit of about 1 nm, preferably 15 nm or more, more preferably 30 nm or more. The inorganic layer with such a thickness can have reliable barrier properties against water vapor and prevent degradation of the transparent conductive layer. On the other hand, the thickness (average thickness) of the inorganic layer may have an upper limit of about 1,000 nm, preferably 300 nm or less, more preferably 200 nm or less. The inorganic layer with such a thickness can form a laminate preferable in terms of flexibility and thickness reduction. The thickness (average thickness) of the inorganic layer is preferably from 10 nm to 300 nm, more preferably from 30 nm to 200 nm.

<Pressure-Sensitive Adhesive Layer>

The pressure-sensitive adhesive layer may be formed using any appropriate type of pressure-sensitive adhesive. Examples of the pressure-sensitive adhesive include a rubber-based pressure-sensitive adhesive, an acrylic pressure-sensitive adhesive, a silicone-based pressure-sensitive adhesive, a urethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, and a cellulose-based pressure-sensitive adhesive.

Among these pressure-sensitive adhesives, those having a high level of optical transparency and weather resistance or heat resistance and exhibiting an appropriate level of wettability and adhesive properties such as cohesiveness and adhesion are preferably used. An acrylic pressure-sensitive adhesive is preferably used because it has such properties.

<<(Meth)Acryl-Based Polymer>>

Such an acrylic pressure-sensitive adhesive includes, as a base polymer, a (meth)acryl-based polymer having an alkyl (meth)acrylate monomer unit in its main skeleton. As used herein, the term “alkyl (meth)acrylate” refers to alkyl acrylate and/or alkyl methacrylate, and “(meth)” is used in the same meaning in the description. The alkyl (meth)acrylate used to form the main skeleton of the acryl-based polymer may have a straight or branched chain alkyl group of 1 to 20 carbon atoms. Examples of the alkyl (meth)acrylate include methyl (meth)acrylate, ethyl (meth)acrylate, propyl (meth)acrylate, butyl (meth)acrylate, 2-ethylhexyl (meth)acrylate, isooctyl (meth)acrylate, isononyl (meth)acrylate, isomyristyl (meth)acrylate, and lauryl (meth)acrylate. These may be used singly or in any combination. The average carbon number of such alkyl groups is preferably from 3 to 9.

To improve adhesion or heat resistance, one or more copolymerizable monomers may be incorporated into the (meth)acryl-based polymer by copolymerization. Examples of such copolymerizable monomers include hydroxyl group-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate; carboxyl group-containing monomers such as (meth)acrylic acid, carboxyethyl (meth)acrylate, carboxypentyl (meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid; and phosphate group-containing monomers such as 2-hydroxyethylacryloyl phosphate.

Examples of such monomers for modification also include (N-substituted) amide monomers such as (meth)acrylamide, N,N-dimethyl (meth)acrylamide, N-butyl (meth)acrylamide, N-methylol (meth)acrylamide, and N-methylolpropane (meth)acrylamide; alkylaminoalkyl (meth)acrylate monomers such as aminoethyl (meth)acrylate, N,N-dimethylaminoethyl (meth)acrylate, and tert-butylaminoethyl (meth)acrylate; alkoxyalkyl (meth)acrylate monomers such as methoxyethyl (meth)acrylate and ethoxyethyl (meth)acrylate; succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acryloylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Examples of modifying monomers that may also be used include vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidyl (meth)acrylate; glycol acrylate monomers such as polyethylene glycol (meth)acrylate, polypropylene glycol (meth)acrylate, methoxyethylene glycol (meth)acrylate, and methoxypolypropylene glycol (meth)acrylate; and acrylic ester monomers such as tetrahydrofurfuryl (meth)acrylate, fluoro(meth)acrylate, silicone (meth)acrylate, and 2-methoxyethyl acrylate.

Concerning the weight ratios of all constituent monomers, the alkyl (meth)acrylate should be a main component of the (meth)acryl-based polymer, and the content of the copolymerizable monomer used to form the (meth)acryl-based polymer is preferably, but not limited to, 0 to about 20%, more preferably about 0.1 to about 15%, even more preferably about 0.1 to about 10%, based on the total weight of all constituent monomers.

Among these copolymerizable monomers, hydroxyl group-containing monomers and carboxyl group-containing monomers are preferably used in view of adhesion or durability. These monomers can serve as a reactive site to a crosslinking agent. Hydroxyl group-containing monomers and carboxyl group-containing monomers are highly reactive with intermolecular crosslinking agents and thus are preferably used to improve the cohesiveness or heat resistance of the resulting pressure-sensitive adhesive layer.

When a hydroxyl group-containing monomer and a carboxyl group-containing monomer are added as copolymerizable monomers, the content of the carboxyl group-containing monomer is preferably from 0.1 to 10% by weight, and the content of the hydroxyl group-containing monomer is preferably from 0.01 to 2% by weight, while these copolymerizable monomers should be used at the content described above. The content of the carboxyl group-containing monomer is more preferably from 0.2 to 8% by weight, even more preferably from 0.6 to 6% by weight. The content of the hydroxyl group-containing monomer is more preferably from 0.03 to 1.5% by weight, even more preferably from 0.05 to 1% by weight.

The (meth)acryl-based polymer for use in the invention generally has a weight average molecular weight in the range of 500,000 to 3,000,000. In view of durability, particularly, heat resistance, the (meth)acryl-based polymer used preferably has a weight average molecular weight of 700,000 to 2,700,000, more preferably 800,000 to 2,500,000. A weight average molecular weight of less than 500,000 is not preferred in terms of heat resistance. If the weight average molecular weight is more than 3,000,000, a large amount of a diluent solvent can be necessary for adjusting the viscosity to be suitable for coating, which may increase cost and is not preferred. The term “weight average molecular weight” refers to the value calculated as a polystyrene-equivalent molecular weight from a measurement obtained by gel permeation chromatography (GPC).

The (meth)acryl-based polymer described above can be produced by a method appropriately selected from known methods such as solution polymerization, bulk polymerization, emulsion polymerization, and various types of radial polymerization. The resulting (meth)acryl-based polymer may be any form such as a random copolymer, a block copolymer, or a graft copolymer.

In solution polymerization, for example, ethyl acetate, toluene, or the like may be used as a polymerization solvent. An example of solution polymerization includes performing the reaction under a stream of inert gas such as nitrogen in the presence of a polymerization initiator typically under the reaction conditions of a temperature of about 50 to about 70° C. and a time period of about 5 to about 30 hours.

Any appropriately selected polymerization initiator, chain transfer agent, emulsifier, or other agents may be used for radical polymerization. The weight average molecular weight of the (meth)acryl-based polymer can be adjusted by controlling the amount of the polymerization initiator or the chain transfer agent or by controlling the reaction conditions. The amount of these agents may be adjusted as appropriate depending on the type of these agents.

Examples of the polymerization initiator include, but are not limited to, azo initiators such as 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydra to (VA-057 manufactured by Wako Pure Chemical Industries, Ltd.); persulfates such as potassium persulfate and ammonium persulfate; peroxide initiators such as di(2-ethylhexyl) peroxydicarbonate, di(4-tert-butylcyclohexyl) peroxydicarbonate, di-sec-butyl peroxydicarbonate, tert-butyl peroxyneodecanoate, tert-hexyl peroxypivalate, tert-butyl peroxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butyl peroxyisobutyrate, 1,1-di(tert-hexylperoxy)cyclohexane, tert-butyl hydroperoxide, and hydrogen peroxide; and a redox system initiator including a combination of a peroxide and a reducing agent, such as a combination of a persulfate and sodium hydrogen sulfite or a combination of a peroxide and sodium ascorbate.

These polymerization initiators may be used singly or in combination of two or more. The total content of the polymerization initiator(s) is preferably from about 0.005 to about 1 part by weight, more preferably from about 0.02 to about 0.5 parts by weight, based on 100 parts by weight of the monomers.

For example, when the (meth)acryl-based polymer with a weight average molecular weight as shown above is produced using 2,2′-azobisisobutyronitrile as a polymerization initiator, the amount of the polymerization initiator is preferably from about 0.06 to about 0.2 parts by weight based on 100 parts by weight of all the monomers.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. The chain transfer agents may be used singly or in combination of two or more. The total content of the chain transfer agent(s) should be about 0.1 parts by weight or less, based on 100 parts by weight of all the monomers.

Examples of the emulsifier for use in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used singly or in combination of two or more.

The emulsifier may be a reactive emulsifier. Examples of such an emulsifier having an introduced radically-polymerizable functional group, such as a propenyl group or an allyl ether group, include AQUALON HS-10, HS-20, KH-10, BC-05, BC-10, and BC-20 (all manufactured by DKS Co., Ltd.) and ADEKA REASOAP SE10N (manufactured by ADEKA CORPORATION). The reactive emulsifier is preferred because after polymerization, it can improve water resistance by being incorporated into the polymer chain. Based on 100 parts by weight of all the monomers, the emulsifier is preferably used in an amount of 0.3 to 5 parts by weight, more preferably 0.5 to 1 part by weight, in view of polymerization stability or mechanical stability.

<<Crosslinking Agent>>

The pressure-sensitive adhesive preferably further contains a crosslinking agent. A polyfunctional compound may be added to the pressure-sensitive adhesive, and such a polyfunctional compound may be an organic crosslinking agent or a polyfunctional metal chelate. Examples of the organic crosslinking agent include an epoxy crosslinking agent, an isocyanate crosslinking agent, an imine crosslinking agent, and a peroxide crosslinking agent. One or more of these crosslinking agents may be used singly or in combination. The organic crosslinking agent is preferably an isocyanate crosslinking agent. The polyfunctional metal chelate is a compound containing a polyvalent metal covalently or coordinately bonded to an organic compound. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include an alkyl ester, an alcohol compound, a carboxylic acid compound, an ether compound, and a ketone compound.

The crosslinking agent is preferably an isocyanate crosslinking agent and/or a peroxide crosslinking agent. Examples of compounds for use as isocyanate crosslinking agents include isocyanate monomers such as tolylene diisocyanate, chlorophenylene diisocyanate, tetramethylene diisocyanate, xylylene diisocyanate, diphenylmethane diisocyanate, and hydrogenated diphenylmethane diisocyanate, and isocyanate, isocyanurate, or biuret compounds produced by adding any of these isocyanate monomers to trimethylolpropane or other compounds; and urethane prepolymer type isocyanates produced by addition reaction of any of these isocyanate compounds with polyether polyols, polyester polyols, acrylic polyols, polybutadiene polyols, polyisoprene polyols, or other polyols. Particularly preferred is a polyisocyanate compound such as one selected from the group consisting of hexamethylene diisocyanate, hydrogenated xylylene diisocyanate, and isophorone diisocyanate, or a polyisocyanate compound derived therefrom. Examples of one selected from the group consisting of hexamethylene diisocyanate, hydrogenated xylylene diisocyanate, and isophorone diisocyanate, or a polyisocyanate compound derived therefrom include hexamethylene diisocyanate, hydrogenated xylylene diisocyanate, isophorone diisocyanate, polyol-modified hexamethylene diisocyanate, polyol-modified hydrogenated xylylene diisocyanate, trimer-type hydrogenated xylylene diisocyanate, and polyol-modified isophorone diisocyanate. The listed polyisocyanate compounds are preferred because their reaction with a hydroxyl group quickly proceeds as if an acid or a base contained in the polymer acts as a catalyst, which particularly contributes to the rapidness of the crosslinking.

Any peroxide capable of generating active radical species upon heating or exposure to light and capable of crosslinking the base polymer in the pressure-sensitive adhesive can be used appropriately. In view of workability or stability, a peroxide with a one-minute half-life temperature of 80° C. to 160° C. is preferably used, and a peroxide with a one-minute half-life temperature of 90° C. to 140° C. is more preferably used.

Examples of peroxides that may be used include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoyl peroxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutyrate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), and dibenzoyl peroxide (one-minute half-life temperature: 130.0° C.) are preferably used because they can provide higher crosslinking reaction efficiency.

The half life of a peroxide, which is an indicator of how fast the peroxide can be decomposed, refers to the time required for the remaining amount of the peroxide to reach one half of the original amount. The decomposition temperature required for a certain half life time and the half life time obtained at a certain temperature are shown in catalogs furnished by manufacturers, such as Organic Peroxide Catalog, 9th Edition, May, 2003, furnished by NOF CORPORATION.

The crosslinking agent is preferably used in an amount of 0.01 to 20 parts by weight, more preferably 0.03 to 10 parts by weight, based on 100 parts by weight of the (meth)acryl-based polymer. If the amount of the crosslinking agent is less than 0.01 parts by weight, the adhesive may tend to have insufficient cohesive strength, and foaming may occur during the heating of the adhesive. On the other hand, if it is more than 20 parts by weight, the pressure-sensitive adhesive may have insufficient moisture resistance and may easily peel off in a reliability test and other tests.

The above isocyanate crosslinking agents may be used singly or in combination of two or more. The total content of the isocyanate crosslinking agent(s) is preferably from 0.01 to 2 parts by weight, more preferably from 0.02 to 2 parts by weight, even more preferably from 0.05 to 1.5 parts by weight, based on 100 parts by weight of the (meth)acryl-based polymer. The content may be appropriately determined taking into account cohesive strength, the ability to prevent delamination in a durability test, or other properties.

The above peroxides may be used singly or in combination of two or more. The total content of the peroxide(s) is preferably from 0.01 to 2 parts by weight, more preferably from 0.04 to 1.5 parts by weight, even more preferably from 0.05 to 1 part by weight, based on 100 parts by weight of the (meth)acryl-based polymer. The content may be appropriately selected in these ranges for control of workability, reworkability, crosslinking stability, removability, or other properties.

The amount of decomposition of the peroxide can be determined, for example, by a method of measuring the peroxide residue after the reaction process by high performance liquid chromatography (HPLC).

More specifically, for example, after the reaction process, about 0.2 g of each pressure-sensitive adhesive is taken out and immersed in 10 ml of ethyl acetate and subjected to shaking extraction at 25° C. and 120 rpm for 3 hours in a shaker, and then allowed to stand at room temperature for 3 days. Subsequently, 10 ml of acetonitrile is added, and the resulting mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

<Coupling Agent>

The pressure-sensitive adhesive preferably contains a coupling agent. The pressure-sensitive adhesive layer made from a coupling agent-containing pressure-sensitive adhesive can have improved adhesion to the inorganic layer. Examples of the coupling agent include a silane coupling agent, a zirconium coupling agent, and a titanate coupling agent. One or more of these coupling agents may be selected and used.

Any conventionally known silane coupling agents may be used. Examples include epoxy group-containing silane coupling agents such as γ-glycidoxypropyltrimethoxysilane, γ-glycidoxypropyltriethoxysilane, γ-glycidoxypropylmethyldiethoxysilane, and 2-(3,4-epoxycyclohexyl)ethyltrimethoxysilane; amino group-containing silane coupling agents such as 3-aminopropyltrimethoxysilane, N-2-(aminoethyl)-3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; and isocyanate group-containing silane coupling agents such as 3-isocyanatopropyltriethoxysilane.

A compound having a titanium or zirconium atom and at least one reactive group (e.g., a hydrophilic alkoxy group reactive with a hydroxyl group) may be used as a titanium or zirconium coupling agent. Another compound having a titanium or zirconium atom, the reactive hydrophilic group, and a hydrophobic organic functional group (hydrophobic group) having a carboxyl group, a phosphate group, a pyrophosphate group, a phosphite group, a sulfonyl group, an amino group, or other groups may also be used as a titanium or zirconium coupling agent.

The titanium coupling agent may be, for example, a titanium alkoxide (alkyl titanate) or a titanium chelate (a compound containing titanium coordinated or bonded to an alkoxy group or other groups and an additional organic functional group). Examples of the titanium coupling agent include isopropyltriisostearoyl titanate, isopropyltri-n-dodecylbenzenesulfonyl titanate, isopropyltris(dioctylpyrophosphate) titanate, tetraisopropylbis(dioctylphosphite) titanate, tetraoctylbis(ditridecylphosphite) titanate, tetra(2,2-diallyloxymethyl-1-butyl)bis(di-tridecyl)phosphit e titanate, bis(dioctylpyrophosphate)oxyacetate titanate, bis(dioctylpyrophosphate)ethylene titanate, isopropyltrioctanoyl titanate, isopropyldimethacryloylisostearoyl titanate, isopropylisostearoyldiacryl titanate, isopropyltri(dioctylphosphate) titanate, isopropyltricumylphenyl titanate, isopropyltri(N-aminoethyl-aminoethyl) titanate, tetraisopropyl titanate, tetra-n-butyl titanate, butyl titanate dimer, tetrakis(2-ethylhexyl) titanate, tetrastearyl titanate, tetramethyl titanate, diethoxybis(acetylacetonato)titanium, diisopropylbis(acetylacetonato)titanium, diisopropoxybis(ethylacetoacetate)titanium, isopropoxy(2-ethyl-1,3-hexanediolato)titanium, di(2-ethylhexoxy)bis(2-ethyl-1,3-hexanediolato)titanium, di-n-butoxybis(triethanolaminato)titanium, titanium tetraacetylacetonate, hydroxybis(lactato)titanium, dicumylphenyloxyacetate titanate, and diisostearoylethylene titanate.

Specific examples of the titanium coupling agent include PLENACT series manufactured by Ajinomoto Fine-Techno Co., Inc., such as PLENACT KR-TTS, KR-46B, KR-55, KR-41B, KR-385, KR-138S, KR-238S, 338X, KR44, and KR9SA; ORGATIX series manufactured by Matsumoto Fine Chemical Co., Ltd., such as ORGATIX TA-10, TA-25, TA-22, TA-30, TC-100, TC-200, TC-401, and TC-750; and products manufactured by Nippon Soda Co., Ltd., such as A-1, B-1, TOT, TST, TAA, TAT, TLA, TOG, TBSTA, A-10, TBT, B-2, B-4, B-7, B-10, TBSTA-400, TTS, TOA-30, TSDMA, TTAB, and TTOP.

The zirconium coupling agent may be, for example, a zirconium alkoxide or a zirconium chelate (a compound containing zirconium coordinated or bonded to an alkoxy group or other groups and an additional organic functional group). Examples of the zirconium coupling agent include ethylenically unsaturated zirconate-containing compounds and neoalkoxyzirconate-containing compounds, such as neoalkoxytrisneodecanoyl zirconate, neoalkoxytris(dodecyl)benzenesulfonyl zirconate, neoalkoxytris(dioctyl)phosphate zirconate, neoalkoxytris(dioctyl)pyrophosphate zirconate, neoalkoxytris(ethylenediamino)ethyl zirconate, neoalkoxytris(m-amino)phenyl zirconate, tetra(2,2-diallyloxymethyl)butyl, di(ditridecyl)phosphito zirconate, neopentyl(diallyl)oxy, trineodecanoyl zirconate, neopentyl(diallyl)oxy, tri(dodecyl)benzene-sulfonyl zirconate, neopentyl(diallyl)oxy, tri(dioctyl)phosphato zirconate, neopentyl(diallyl)oxy, tri(dioctyl)pyro-phosphato zirconate, neopentyl(diallyl)oxy, tri(N-ethylenediamino)ethylzirconate, neopentyl(diallyl)oxy, tri(m-amino)phenyl zirconate, neopentyl(diallyl)oxy, trimethacryl zirconate, neopentyl(diallyl)oxy, triacryl zirconate, dineopentyl(diallyl)oxy, diparaminobenzoyl zirconate, dineopentyl(diallyl)oxy, di(3-mercapto)propionic zirconate, zirconium(IV) 2,2-bis(2-propenolatomethyl)butanolato, cyclodi[2,2-(bis2-propenolatomethyl)butanolato]pyrophosphato-O,O, neoalkoxytrisneodecanoyl zirconate, neoalkoxytris(dodecyl)benzenesulfonyl zirconate, neoalkoxytris(dioctyl)phosphate zirconate, neoalkoxytris(dioctyl)pyrophosphate zirconate, neoalkoxytris(ethylenediamino)ethyl zirconate, and neoalkoxytris(m-amino)phenyl zirconate. Examples of the zirconium coupling agent also include tetra-n-propoxyzirconium, tetra-n-butoxyzirconium, zirconium tetraacetylacetonate, zirconium tributoxyacetylacetonate, zirconium tributoxystearate, zirconium dibutoxybis(acetylacetonate), zirconium dibutoxybis(acetylacetonate), zirconium tributoxyethylacetoacetate, and zirconium monobutoxyacetylacetonate bis(ethylacetoacetate).

Specific examples of the zirconium coupling agent include Ken-React series manufactured by Kenrich Petrochemicals, Inc., such as Ken-React KZ55, NZ01, NZ09, NZ12, NZ38, NZ44, NZ97, NZ33, NZ39, NZ37, NZ66A, and KZTPP; and ORGATIX series manufactured by Matsumoto Fine Chemical Co., Ltd., such as ORGATIX ZA-40, ZA-65, ZC-150, ZC-540, ZC-570, and ZC-580.

The coupling agent is preferably added in an amount of 5 parts by weight or less, more preferably in an amount of 0.001 to 5 parts by weight, to 100 parts by weight of the base polymer (e.g., the (meth)acryl-based polymer). The use of 0.001 parts by weight or more of the coupling agent is effective in improving the adhesion to the inorganic layer. On the other hand, the use of more than 5 parts by weight of the coupling agent may affect the adhesive properties. The content of the coupling agent is preferably from 0.01 to 3 parts by weight, more preferably from 0.1 to 1 part by weight.

If necessary, the pressure-sensitive adhesive may further contain a tackifier, a plasticizer, a filler of glass fibers, glass beads, metal powder, or any other inorganic powder, a pigment, a colorant, a filler, an antioxidant, an ultraviolet absorber, or other various additives without departing from the object of the invention. Fine particles may also be added to the adhesive so that a pressure-sensitive adhesive layer with light diffusion properties can be formed.

When the pressure-sensitive adhesive is used to form a pressure-sensitive adhesive layer, it is preferred that the total content of the crosslinking agent should be controlled and that the effect of the crosslinking temperature or the crosslinking time should be carefully taken into account.

The crosslinking temperature and the crosslinking time may be controlled depending on the type of the crosslinking agent to be used. The crosslinking temperature is preferably 170° C. or lower.

The crosslinking process may be performed at the temperature where the process of drying the pressure-sensitive adhesive layer is performed, or an independent crosslinking process may be performed after the drying process.

The crosslinking time may be determined in view of productivity or workability. The crosslinking time is generally from about 0.2 to about 20 minutes, preferably from about 0.5 to about 10 minutes.

The pressure-sensitive adhesive layer can be formed by, for example, a method including applying the pressure-sensitive adhesive to a release-treated separator or the like, removing the polymerization solvent and other components by drying to forma pressure-sensitive adhesive layer, and then transferring the pressure-sensitive adhesive layer onto the inorganic layer of the polarizing film. Alternatively, the pressure-sensitive adhesive layer can be formed by a method including applying the pressure-sensitive adhesive to the inorganic layer of the polarizing film and removing the polymerization solvent and other components by drying to form a pressure-sensitive adhesive layer on the polarizing film. In the process of applying the pressure-sensitive adhesive, if necessary, one or more solvents other than the polymerization solvent may be newly added to the pressure-sensitive adhesive.

A silicone release liner is preferably used as the release-treated separator. The pressure-sensitive adhesive composition may be applied to such a liner and dried to form a pressure-sensitive adhesive layer. In this process, any appropriate method may be used for drying the pressure-sensitive adhesive, depending on the purpose. Preferably, a method of heating and drying the coating is used. The heating and drying temperature is preferably from 40° C. to 200° C., more preferably from 50° C. to 180° C., even more preferably from 70° C. to 170° C. When the heating temperature falls within the ranges, a pressure-sensitive adhesive with excellent adhesive properties can be obtained.

The drying may be performed for any appropriate time. The drying time is preferably from 5 seconds to 20 minutes, more preferably from 5 seconds to 10 minutes, even more preferably from 10 seconds to 5 minutes.

The surface of the inorganic layer of the polarizing film may also be covered with an anchor layer or subjected to any adhesion facilitating treatment such as a corona treatment or a plasma treatment before the pressure-sensitive adhesive layer is formed thereon. The surface of the pressure-sensitive adhesive layer may also be subjected to an adhesion facilitating treatment.

Any of various coating agents may be used to form the anchor layer for improving adhesion, controlling refractive index, imparting conductivity, or achieving other purposes. A filler, particles, a conductive polymer, or other materials may be used in the coating agent, depending on the purpose. Examples of a binder resin that may be used in the coating agent include, but are not limited to, epoxy resins, isocyanate resins, polyurethane resins, polyester resins, polymers containing amino groups in the molecule, ester urethane resins, and organic reactive group-containing resins (polymers) such as various acrylic resins containing oxazoline groups or other groups.

Various methods may be used to form the pressure-sensitive adhesive layer. Examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or other coaters.

The thickness of the pressure-sensitive adhesive layer is typically, but not limited to, about 1 to about 100 μm, preferably 2 to 50 μm, more preferably 2 to 40 μm, even more preferably 5 to 35 μm.

When the surface of the pressure-sensitive adhesive layer is exposed, the pressure-sensitive adhesive layer may be protected by a release-treated sheet (separator) until it is actually used.

Examples of the material used to form such a separator include a plastic film such as a polyethylene, polypropylene, polyethylene terephthalate, or polyester film, a porous material such as a paper sheet, a cloth, or a nonwoven fabric, and appropriate thin materials such as a net, a foamed sheet, a metal foil, and a laminate thereof. A plastic film is advantageously used because of its good surface smoothness.

Such a plastic film may be of any type capable of protecting the pressure-sensitive adhesive layer. For example, such a plastic film may be a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The separator generally has a thickness of about 5 to about 200 μm, preferably about 5 to about 100 μm. If necessary, the separator may be subjected to a release treatment and an anti-pollution treatment with a silicone, fluoride, long-chain alkyl, or fatty acid amide release agent, a silica powder or the like, or subjected to an antistatic treatment of coating type, kneading and mixing type, vapor-deposition type, or the like. In particular, when the surface of the separator is appropriately subjected to a release treatment such as a silicone treatment, a long-chain alkyl treatment, or a fluorine treatment, the releasability from the pressure-sensitive adhesive layer can be further improved.

The release-treated sheet used in the preparation of the pressure-sensitive adhesive layer attached polarizing film may be used by itself as a separator for the pressure-sensitive adhesive layer attached polarizing film, so that the process can be simplified.

<Transparent Conductive Member>

The transparent conductive member is a member including a transparent conductive layer. The transparent conductive member is not particularly limited and may be of any known type, such as a member including a transparent substrate such as a transparent film and a transparent conductive layer provided on the transparent substrate or a member including a transparent conductive layer and a liquid crystal cell.

The transparent substrate may be of any type having transparency, such as a resin film or a substrate made of glass or the like (e.g., a substrate in the form of a sheet, a film, or a plate). A resin film is particularly preferred. The thickness of the transparent substrate is preferably, but not limited to, about 10 to about 200 μm, more preferably about 15 to about 150 μm.

The resin film may be made of any material, such as any of various plastic materials having transparency. Examples of such materials include polyester resins such as polyethylene terephthalate and polyethylene naphthalate, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. Among them, polyester resins, polyimide resins, and polyethersulfone resins are particularly preferred.

The surface of the transparent substrate may be previously subjected to sputtering, corona discharge treatment, flame treatment, ultraviolet irradiation, electron beam irradiation, chemical treatment, etching treatment such as oxidation, or undercoating treatment so that the transparent substrate can have improved adhesion to the transparent conductive layer formed thereon. Before the transparent conductive layer is formed, if necessary, the transparent substrate may be subjected to solvent washing or ultrasonic washing for removal of dust and cleaning.

Examples of the material used to form the transparent conductive layer include, but not limited to, gold, silver, copper, platinum, palladium, aluminum, nickel, chromium, titanium, iron, cobalt, tin, magnesium, tungsten, and other metals, and alloys thereof. Examples of the material used to form the transparent conductive layer also include oxides of metals such as indium, tin, zinc, gallium, antimony, zirconium, and cadmium. Specific examples include metal oxides including indium oxide, tin oxide, titanium oxide, cadmium oxide, and any mixture thereof. Other metal compounds including copper iodide may also be used to form the transparent conductive layer. If necessary, the metal oxides may be doped with an oxide of any metal from the group shown above. For example, tin oxide-doped indium oxide (ITO) and antimony-doped tin oxide are preferably used, and in particular, ITO is preferably used. ITO preferably includes 80 to 99% by weight of indium oxide and 1 to 20% by weight of tin oxide. In general, the transparent conductive layer to be used may have a surface resistance of 1.0×10¹²Ω/□ or less.

The ITO may be crystalline or amorphous. The crystalline ITO can be obtained by high-temperature sputtering or further heating amorphous ITO. The iodine-induced degradation can significantly occur on amorphous ITO. Therefore, the pressure-sensitive adhesive layer attached polarizing film according to the invention is particularly effective for use on amorphous ITO.

The thickness of the transparent conductive layer is preferably, but not limited to, 7 nm or more, more preferably 10 nm or more, even more preferably 12 to 60 nm, further more preferably 15 to 45 nm, still more preferably 18 to 45 nm, yet more preferably 20 to 30 nm. The transparent conductive layer with a thickness of less than 7 nm may be easily degraded by iodine and tend to be more variable in electric resistance. On the other hand, the transparent conductive layer with a thickness of more than 60 nm may be produced with lower productivity at higher cost and tend to have a lower level of optical properties.

The transparent conductive layer may be formed by any conventionally known method. Examples include vacuum deposition, sputtering, and ion plating. Any appropriate method may also be used depending on the desired thickness.

The thickness of the substrate including the transparent conductive layer may be from 15 to 200 μm. For a reduction in thickness, the thickness of the substrate including the transparent conductive layer is preferably from 15 to 150 μm, more preferably from 15 to 50 μm. When used in a resistive system, the substrate including the transparent conductive layer may have a thickness of, for example, 100 to 200 μm. When used in a capacitive system, the substrate including the transparent conductive layer preferably has a thickness of, for example, 15 to 100 μm and more preferably has a thickness of 15 to 50 μm, even more preferably 20 to 50 μm, in particular, to meet a demand for a further reduction in thickness in recent years.

If necessary, an undercoat layer, an oligomer blocking layer, or any additional layer may be provided between the transparent conductive layer and the transparent substrate.

The member including a transparent conductive layer and a liquid crystal cell may be a product for use in image display devices such as various liquid crystal display devices. Such a product includes a liquid crystal cell including a structure of substrate (e.g., glass substrate)/liquid crystal layer/substrate and a transparent conductive layer provided on a side of the substrate opposite to its side in contact with the liquid crystal layer. When a color filter substrate is provided on the liquid crystal cell, the transparent conductive layer may be provided on the color filter. The transparent conductive layer may be formed by the above method on the substrate of the liquid crystal cell.

When the pressure-sensitive adhesive layer attached polarizing film according to the invention is bonded to a transparent conductive layer, the rate of change in the resistance of the transparent conductive layer is preferably less than 150%, more preferably 130% or less, even more preferably 120% or less. The rate of resistance change is preferably less than 150% for the prevention of static electricity-induced unevenness or for shielding function, and preferably from 10 to 20% for sensor applications. The rate of change in the resistance of the transparent conductive layer can be determined by the method described in the EXAMPLES section.

<Image Display Device>

The laminate of the invention is advantageously used to forma substrate (member) as a component of or for use in a device such as an input device (e.g., touch panel) or an image display device (e.g., liquid crystal display device, organic electroluminescence (EL) display device, plasma display panel (PDP), or electronic paper) equipped with an input device (e.g., touch panel). In particular, the laminate of the invention is advantageously used to form an optical substrate for use in a touch panel. In addition, the laminate of the invention may be used regardless of touch panel type such as resistive or capacitive type.

The laminate of the invention may be subjected to certain processes such as cutting, resist printing, etching, and silver ink printing. The resulting transparent conductive film may be used as a substrate (optical member) for use in an optical device. The substrate for use in an optical device may be of any type having optical properties, for example, which may be a substrate (member) as a component of or for use in a device such as an image display device (e.g., liquid crystal display device, organic electroluminescence (EL) display device, plasma display panel (PDP), or electronic paper) or an input device (e.g., touch panel).

As mentioned above, the laminate of the invention can prevent the degradation of a transparent conductive layer even when the transparent conductive layer is placed on the pressure-sensitive adhesive layer of the pressure-sensitive adhesive layer attached polarizing film, and can also suppress the increase in the surface resistance of the transparent conductive layer. Thus, the pressure-sensitive adhesive layer attached polarizing film according to the invention is advantageously used to form any image display device including a structure in which a transparent conductive layer is in contact with the pressure-sensitive adhesive layer of the pressure-sensitive adhesive layer attached polarizing film. For example, an image display device can be formed by bonding the pressure-sensitive adhesive layer attached polarizing film according to the invention to a liquid crystal panel including a transparent conductive layer in such a manner that the pressure-sensitive adhesive layer of the pressure-sensitive adhesive layer attached polarizing film is in contact with the transparent conductive layer of the liquid crystal panel.

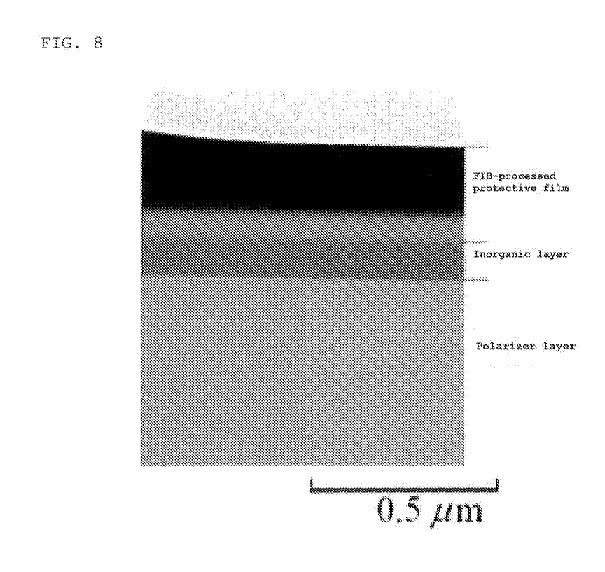

More specifically, examples include an image display device in which a transparent conductive layer is used as an antistatic layer; and an image display device in which a transparent conductive layer is used as a touch panel electrode. Specifically, the image display device in which a transparent conductive layer is used as an antistatic layer may have, for example, a structure including, as shown in FIG. 5, a polarizing film 1, a pressure-sensitive adhesive layer 2, an antistatic layer 3, a glass substrate 4, a liquid crystal layer 5, a driving electrode 6, a glass substrate 4, a pressure-sensitive adhesive layer 2, and a polarizing film 1, stacked in this order, in which the antistatic layer 3 and the driving electrode 6 are each formed of a transparent conductive layer. The pressure-sensitive adhesive layer attached polarizing film according to the invention may be used to form an upper side (viewer side) part (the polarizing film 1 and the pressure-sensitive adhesive layer 2) of the image display device. The image display device in which a transparent conductive layer is used as a touch panel electrode may have, for example, a structure (an in-cell touch panel of FIG. 6) including a polarizing film 1, a pressure-sensitive adhesive layer 2, a sensor layer 7 also serving as an antistatic layer, a glass substrate 4, a liquid crystal layer 5, a sensor layer 8 also serving as a driving electrode, a glass substrate 4, a pressure-sensitive adhesive layer 2, and a polarizing film 1, stacked in this order, or a structure (an on-cell touch panel of FIG. 7) including a polarizing film 1, a pressure-sensitive adhesive layer 2, a sensor layer 7 also serving as an antistatic layer, a sensor layer 9, a glass substrate 4, a liquid crystal layer 5, a driving electrode 6, a glass substrate 4, a pressure-sensitive adhesive layer 2, and a polarizing film 1, stacked in this order, in which the sensor layer 7 also serving as an antistatic layer, the sensor layer 9, and the driving electrode 6 are each formed of a transparent conductive layer. The pressure-sensitive adhesive layer attached polarizing film according to the invention may be used to form an upper side (viewer side) part (the polarizing film 1 and the pressure-sensitive adhesive layer 2) of the image display device.

### EXAMPLES

Hereinafter, the invention will be more specifically described with reference to examples, which, however, are not intended to limit the invention. In each example, “parts” and are all by weight. Unless otherwise specified below, the conditions of standing at room temperature include 23° C. and 65% RH in all cases.

<Measurement of Weight Average Molecular Weight of (Meth)Acryl-Based Polymer>

The weight average molecular weight of (meth)acryl-based polymers was determined using gel permeation chromatography (GPC).
Analyzer: HLC-8120GPC manufactured by TOSOH CORPORATION
Columns: GM7000H_{XL}+GMH_{XL}+GMH_{XL} manufactured by TOSOH CORPORATION
Column size: Each 7.8 mmφ×30 cm, 90 cm in total
Column temperature: 40° C.
Flow rate: 0.8 ml/minute
Injection volume: 100 μl
Eluent: Tetrahydrofuran
Detector: Differential refractometer (RI)
Standard sample: Polystyrene

<Transparent Protective Films>

Transparent Protective Film 1

A 40-μm-thick, lactone-ring-structure-containing (meth)acrylic resin film (water-vapor permeability 96 g/m²·day) was subjected to a corona treatment and then used as transparent protective film 1 (represented by acryl (40) in Table 2).

Transparent Protective Film 2

A 20-μm-thick, lactone-ring-structure-containing (meth)acrylic resin film (water-vapor permeability 48 g/m²·day) was subjected to a corona treatment and then used as transparent protective film 2 (represented by acryl (20) in Table 2).

Transparent Protective Film 3

A 40-μm-thick, cyclic polyolefin film (ZEONOR manufactured by Zeon Corporation, water-vapor permeability 11 g/m²·day) was subjected to a corona treatment and then used as transparent protective film 3 (represented by COP (40) in Table 2).

<Preparation of Thin Polarizer>

A thin polarizing coating was prepared as follows. First, a laminate including an amorphous PET substrate and a 9-μm-thick PVA layer formed thereon was subjected to auxiliary in-air stretching at a stretching temperature of 130° C. to form a stretched laminate. Subsequently, the stretched laminate was subjected to dyeing to form a dyed laminate, and the dyed laminate was subjected to stretching in an aqueous boric acid solution at a stretching temperature of 65° C. to a total stretch ratio of 5.94 times, so that an optical film laminate was obtained which had a PVA layer stretched together with the amorphous PET substrate. As a result of such two-stage stretching, an optical film laminate having a 5-μm-thick PVA layer formed on the amorphous PET substrate was successfully obtained. In the PVA layer, PVAmolecules were highly oriented. The PVA layer formed a highly-functional polarizing coating in which iodine adsorbed by the dyeing formed a polyiodide ion complex oriented highly in a single direction. In Table 2, the resulting thin polarizing coating is represented by PVA (5). Table 2 also shows the water content of the thin polarizing coating.

<Preparation of Thin Polarizing Film (A1)>

A first transparent protective film (transparent protective film 1 described above (acryl (40))) was bonded to the polarizing coating of the optical film laminate with a polyvinyl alcohol-based adhesive being applied to the surface of the polarizing coating. Subsequently, the amorphous PET substrate was removed, so that a polarizing film having the thin polarizing coating was obtained. Hereinafter, this product is referred to as the thin polarizing film (A1).

<Preparation of Other Thin Polarizing Films>

Thin polarizing films (A2), (A3), and (A4) were obtained as described in the <Preparation of thin polarizing film (A1)> section, except that the first transparent protective film shown in Table 2 was used instead in the preparation of the thin polarizing film. Note that the thin polarizing film (A4) was prepared with no transparent protective film.

<Preparation of Polarizer>

A 60-μm-thick polyvinyl alcohol film with an average degree of polymerization of 2,400 and a degree of saponification of 99.9% by mole was immersed in warm water at 30° C. for 60 seconds so that it was allowed to swell. The film was then dyed by being immersed in an aqueous solution of 0.3% iodine/potassium iodide (0.5/8 in weight ratio) while stretched to 3.5 times. The film was then stretched to a total stretch ratio of 6 times in an aqueous boric ester solution at 65° C. After the stretching, the film was dried in an oven at 40° C. for 3 minutes to give a polarizer (20 μm in thickness). In Table 2, the polarizer is expressed as PVA (20). Table 2 also shows the water content of the polarizer.

<Preparation of Polarizing Film (A5)>

A polarizing film (A5) was prepared by bonding a first transparent protective film (the transparent protective film 1 (acryl (40)) to one surface of the polarizer while a polyvinyl alcohol-based adhesive was applied to the surface.

<Preparation of Pressure-Sensitive Adhesive>

A reaction vessel equipped with a condenser tube, a nitrogen inlet tube, a thermometer, and a stirrer was charged with 99 parts of butyl acrylate, 1 part of 4-hydroxybutyl acrylate, and 3 parts of azobisisobutyronitrile as an initiator (based on 100 parts of all the monomers) together with ethyl acetate. The mixture was allowed to react at 60° C. for 7 hours under a nitrogen gas stream. Ethyl acetate was then added to the reaction liquid to form a solution containing an acryl-based polymer with a weight average molecular weight of 1,000,000 (solid concentration 30% by weight). Based on 100 parts of the solid in the acryl-based polymer solution, 0.1 parts of trimethylolpropane xylylene diisocyanate (Takenate D110N manufactured by Mitsui Chemicals, Inc.), 0.3 parts of dibenzoyl peroxide, and 0.075 parts of γ-glycidoxypropylmethoxysilane (KBM-403 manufactured by Shin-Etsu Chemical Co., Ltd.) were added to the acryl-based polymer solution to form an acrylic pressure-sensitive adhesive solution (C1).

<Preparation of Other Pressure-Sensitive Adhesives>

Acrylic pressure-sensitive adhesive solutions (C2), (C3), (C4), and (C5) were obtained as described above in the <Preparation of pressure-sensitive adhesive> section, except that the composition of all the monomers, the type or content of the crosslinking agent, or the type or content of the coupling agent was changed as shown in Table 3 in the preparation of the pressure-sensitive adhesive.

### Example 1

<Formation of Inorganic Layer>

A 100-nm-thick inorganic layer (B1) was formed on the polarizer (polarizing film) surface of the thin polarizing film (A1) by vapor deposition of silicon oxide by sputtering, so that a polarizing film including an inorganic layer was obtained. After the resulting polarizing film including the inorganic layer was subjected to focused ion beam (FIB) processing (using “HB-2100” (product name) manufactured by Hitachi, Ltd.), the inorganic layer was observed using a field emission transmission electron microscope (FE-TEM) (“HF-2000” (product name) manufactured by Hitachi, Ltd.). FIG. 8 shows the results of the observation.

<Preparation of Pressure-Sensitive Adhesive Layer Attached Polarizing Film>

The acrylic pressure-sensitive adhesive solution (C1) was uniformly applied to the surface of a silicone release agent-treated polyethylene terephthalate film (substrate) with a fountain coater and then dried in an air circulation-type thermostatic oven at 155° C. for 2 minutes, so that a 20-μm-thick pressure-sensitive adhesive layer was formed on the surface of the substrate. Subsequently, the separator including the pressure-sensitive adhesive layer was attached to the inorganic barrier layer (B1) of the polarizing film including the inorganic barrier layer obtained as described above, so that a pressure-sensitive adhesive layer attached polarizing film was obtained.

### Examples 2 to 8

Polarizing films including inorganic layer were obtained as in Example 1, except that the material used to form the inorganic layer and/or the thickness of the inorganic layer was changed as shown in Table 1 in the formation of the inorganic layer. Subsequently, pressure-sensitive adhesive layer attached polarizing films were prepared as in Example 1.

### Examples 9 to 12

Polarizing films including inorganic layer were obtained as in Example 1, except that the thin polarizing film shown in Table 1 was used instead of the thin polarizing film (A1) in the formation of the inorganic layer. Subsequently, pressure-sensitive adhesive layer attached polarizing films were prepared as in Example 1.

### Examples 13 to 16

Pressure-sensitive adhesive layer attached polarizing films were prepared as in Example 1, except that the pressure-sensitive adhesive solution shown in Table 1 was used instead of the acrylic pressure-sensitive adhesive solution (C1) to form the pressure-sensitive adhesive layer in the preparation of the pressure-sensitive adhesive layer attached polarizing film.

### Comparative Examples 1 to 3

Pressure-sensitive adhesive layer attached polarizing films were prepared as in Example 1, except that, as shown in Table 1, the thin polarizing film (A1), (A3), or (A5) was used with no inorganic layer formed thereon.

The pressure-sensitive adhesive layer attached polarizing films (samples) obtained in the examples and the comparative examples were evaluated as described below. Table 1 shows the results of the evaluation.

<Water-Vapor Permeability>

The water-vapor permeability (g/m²·day) of the pressure-sensitive adhesive layer attached polarizing films was determined by 24-hour measurement in an atmosphere at 40° C. and 90% R.H. using PERMATRAN-W manufactured by MOCON Inc.

<Corrosion Resistance Test (Rate of Resistance Change)>

A 15 mm×15 mm piece was cut from a conductive film having an ITO layer formed at its surface (ELECRYSTA P400L (trade name) manufactured by Nitto Denko Corporation). An 8 mm×8 mm cut piece of each of the samples obtained in the examples and the comparative examples was bonded to the center of the cut piece of the conductive film. The resulting laminate was then autoclaved at 50° C. and 5 atm for 15 minutes to give a sample for corrosion resistance measurement. The resulting measurement sample was measured for resistance value using the measuring device mentioned below. The measured value was used as the “initial resistance.”

Subsequently, the measurement sample was stored for 500 hours in an environment at a temperature of 60° C. and a humidity of 90% and then measured for resistance value. The measured value was used as the “resistance after heating and humidification.” The resistance values were measured using HL5500PC manufactured by Accent Optical Technologies, Inc. The rate (%) of resistance change was calculated from the following formula: rate (%) of resistance change={(the resistance after heating and humidification)/(the initial resistance)}×100 using the “initial resistance” and the “resistance after heating and humidification” measured as described above, and then evaluated based on the evaluation criteria below.

### (Evaluation Criteria)

⊙: The rate of resistance change is less than 150% (the heating and humidification-induced increase in resistance is small (good corrosion resistance)).
◯: The rate of resistance change is from 150% to less than 300%.
Δ: The rate of resistance change is from 300% to less than 400%.
x: The rate of resistance change is 400% or more (the heating and humidification-induced increase in resistance is large (poor corrosion resistance)).

<Adhesive Strength>

A 25-mm-wide piece was cut from the sample obtained in each of the examples and the comparative examples. The separator was peeled off from the cut piece, and the remaining part was used as a sample. A SiO₂-coated film (Tetolight OES) was bonded to the pressure-sensitive adhesive layer of the resulting sample. Using an autograph, the peel strength (N/25 mm) between the pressure-sensitive adhesive layer and the inorganic layer was measured at a peel angle of 90 degrees and a peel rate of 300 mm/minute.

<Optical Properties (Measurement of Single Transmittance and Degree of Polarization)>

The optical properties (single transmittance and degree of polarization) of the pressure-sensitive adhesive layer attached polarizing films obtained in the examples and the comparative examples were measured using an integrating sphere-equipped spectral transmittance meter (DOT-3C manufactured by Murakami Color Research Laboratory Co., Ltd.). The measurement of the optical properties was performed before (for initial properties) and after (for optical reliability) the samples were stored for 120 hours in a humidifying oven containing an atmosphere at 60° C. and 90% R.H. The polarizing film including the inorganic layer and the thin polarizing film were subjected to the measurement as they were. The pressure-sensitive adhesive layer attached polarizing film was subjected to the measurement as follows. After the separator was removed from the pressure-sensitive adhesive layer attached polarizing film, the resulting sample was attached to a 0.7-mm-thick non-alkali glass sheet (EG-XG manufactured by Corning Incorporated) with a laminator and then completely bonded to the non-alkali glass sheet by being autoclaved at 50° C. and 0.5 MPa for 15 minutes. The resulting laminate was subjected to the measurement.

The degree of polarization was determined as follows. Two pieces of the same polarizing film were laminated so that their transmission axes were parallel, and the transmittance (parallel transmittance: Tp) of the resulting laminate was substituted into the formula below. Two pieces of the same polarizer were also laminated so that their transmission axes were at right angles, and the transmittance (crossed transmittance: Tc) of the resulting laminate was also substituted into the formula below.

Degree (%) of polarization={(Tp−Tc)/(Tp+Tc)}^{1/2}×100

Each transmittance was expressed as the Y value, which was obtained through luminosity correction using the two-degree field (illuminant C) according to JIS Z 8701 when the transmittance for completely polarized light obtained through a Glan-Taylor prism polarizer was normalized to 100%.

The pressure-sensitive adhesive layer attached polarizing film according to the invention can achieve a single transmittance of 30% or more and a degree of polarization of 90% or more and thus has good optical properties. Its single transmittance is preferably 35% or more, more preferably 42% or more. Its degree of polarization is preferably 90% or more, more preferably 98% or more, even more preferably 99% or more.

TABLE 1

| | | | | | Evaluations | | | | |
|---|---|---|---|---|---|---|---|---|---|
| | | | | Type of | | Corrosion | | Optical properties | |
| | | Inorganic layer | | pressure- | | resistance test | | Single | Polari- |
| | Type of | (B) | | sensitive | Water-vapor | (resistance | Adhesive | transmit- | zation |
| | polarizing | | Thickness | adhesive | permeability | change rate | strength | tance | degree |
| | film (A) | Type | (nm) | layer (C) | (g/m² · day) | (%)) | (N/25 mm) | (%) | (%) |
| Example 1 | A1 | B1 | 100 | C1 | 0.12 | 105.0 | 22 | 42.3 | 99.99 |
| Example 2 | A1 | B2 | 100 | C1 | 0.11 | 107.0 | 21 | 42.3 | 99.99 |
| Example 3 | A1 | B3 | 100 | C1 | 0.14 | 107.0 | 23 | 42.3 | 99.99 |
| Example 4 | A1 | B1 | 10 | C1 | 1.40 | 125.0 | 20 | 42.3 | 99.99 |
| Example 5 | A1 | B1 | 50 | C1 | 0.23 | 110.0 | 22 | 42.3 | 99.99 |
| Example 6 | A1 | B1 | 150 | C1 | 0.10 | 103.0 | 21 | 42.3 | 99.99 |
| Example 7 | A1 | B1 | 200 | C1 | 0.07 | 101.0 | 21 | 42.3 | 99.99 |
| Example 8 | A1 | B1 | 500 | C1 | 0.02 | 100.0 | 22 | 42.3 | 99.99 |
| Example 9 | A2 | B1 | 100 | C1 | 0.11 | 106.0 | 22 | 42.4 | 99.99 |
| Example 10 | A3 | B1 | 100 | C1 | 0.12 | 105.0 | 20 | 42.3 | 99.99 |
| Example 11 | A4 | B1 | 100 | C1 | 0.10 | 105.0 | 21 | 42.2 | 99.99 |
| Example 12 | A5 | B1 | 100 | C1 | 0.24 | 110.0 | 22 | 42.3 | 99.99 |
| Example 13 | A1 | B1 | 100 | C2 | 0.12 | 120.0 | 21 | 42.3 | 99.99 |
| Example 14 | A1 | B1 | 100 | C3 | 0.13 | 103.0 | 21 | 42.3 | 99.99 |
| Example 15 | A1 | B1 | 100 | C4 | 0.11 | 107.0 | 22 | 42.3 | 99.99 |
| Example 16 | A1 | B1 | 100 | C5 | 0.12 | 108.0 | 25 | 42.3 | 99.99 |
| Comparative | A1 | Absent | — | C1 | 80 | 330 | 12 | 42.3 | 99.99 |
| Example 1 | | | | | | | | | |
| Comparative | A3 | Absent | — | C1 | 6 | 150 | 15 | 42.3 | 99.99 |
| Example 2 | | | | | | | | | |
| Comparative | A5 | Absent | — | C1 | 91 | 410.0 | 13 | 42.3 | 99.99 |
| Example 3 | | | | | | | | | |

In Table 1, as to the type of the inorganic layer, B1 represents silicon oxide, B2 aluminum oxide, and B3 silicon nitride.

TABLE 2

| | | | | Type of second |
|---|---|---|---|---|
| Type of | Type of first | Polarizer | | transparent |
| polarizing | transparent | Type and | Water content | protective |
| film (A) | protective film | thickness | (g/m²) | film |
| A1 | Acryl (40) | PVA (5) | 0.6 | Absent |
| A2 | Acryl (20) | PVA (5) | 0.6 | Absent |
| A3 | COP (40) | PVA (5) | 0.6 | Absent |
| A4 | Absent | PVA (5) | 0.6 | Absent |
| A5 | Acryl (40) | PVA (20) | 2.1 | Absent |

TABLE 3

| Pressure-sensitive | Acryl-based polymer | | | | | | | |
|---|---|---|---|---|---|---|---|---|
| adhesive | Monomer | | Crosslinking agent | | | | Coupling agent | |
| Type | composition | Parts | Type | Parts | Type | Parts | Type | Parts |
| C1 | BA/4HBA = 99/1 | 100 | d1 | 0.1 | d3 | 0.3 | d4 | 0.2 |
| C2 | BA/AA = 95/5 | 100 | d2 | 0.5 | d3 | 0.1 | d4 | 0.2 |
| C3 | BA/2HEA = 99/1 | 100 | d1 | 0.1 | d3 | 0.3 | d4 | 0.2 |
| C4 | BA/4HBA = 99/1 | 100 | d1 | 0.1 | d3 | 0.3 | d5 | 0.2 |
| C5 | BA/4HBA = 99/1 | 100 | d1 | 0.1 | d3 | 0.3 | d6 | 0.2 |

In Table 3, as to the composition of the monomers for the acryl-based polymer, BA represents butyl acrylate, 4HBA 4-hydroxybutyl acrylate, 2HEA 2-hydroxyethyl acrylate, and AA acrylic acid;

as to the type of the crosslinking agent, d1 represents trimethylolpropane xylylene diisocyanate (Takenate D110N manufactured by Mitsui Chemicals, Inc.), d2 trimethylolpropane tolylene diisocyanate (CORONATE L manufactured by Nippon Polyurethane Industry Co., Ltd.), and d3 benzoyl peroxide (NYPER BMT manufactured by NOF CORPORATION); and as to the type of the coupling agent, d4 represents a silane coupling agent (KBM-403 manufactured by Shin-Etsu Chemical Co., Ltd.), d5 a zirconium coupling agent (Ken-React NZ33 manufactured by Kenrich Petrochemicals, Inc.), and d6 a titanium coupling agent (PLENACT KR-TTS manufactured by Ajinomoto Fine-Techno Co., Inc.).

### DESCRIPTION OF REFERENCE SIGNS

1: polarizing film
2: pressure-sensitive adhesive layer
3: transparent conductive layer (antistatic layer)
4: glass substrate
5: liquid crystal layer
6: driving electrode
7: sensor layer also serving as antistatic layer
8: sensor layer also serving as driving electrode
9: sensor layer
10: polarizer
11: first transparent protective film
12: second transparent protective film
20: inorganic layer

1. A laminate, comprising:
a pressure-sensitive adhesive layer attached polarizing film comprising a polarizing film and a pressure-sensitive adhesive layer or layers provided on one or both sides of the polarizing film; and
a transparent conductive member comprising a transparent conductive layer in which the transparent conductive member is bonded to the pressure-sensitive adhesive layer attached polarizing film in such a manner that the pressure-sensitive adhesive layer of the pressure-sensitive adhesive layer attached polarizing film is in contact with the transparent conductive layer of the transparent conductive member, wherein
the polarizing film comprises a polarizer and an inorganic layer or layers provided on one or both sides of the polarizer, and
the pressure-sensitive adhesive layer is provided on at least one side of the inorganic layer of the polarizing film,
wherein the inorganic layer or layers is formed by physical vapor deposition or chemical vapor deposition of an inorganic oxide or an inorganic nitride on the surface of the polarizer.

2. The laminate according to claim 1, wherein the polarizing film has a first transparent protective film provided on a first side of the polarizer with no inorganic layer interposed therebetween, and the inorganic layer is provided on only a second side of the polarizer.

3. The laminate according to claim 2, wherein the polarizing film further comprises a second transparent protective film, and the inorganic layer is provided on the second side of the polarizer with the second transparent protective film interposed therebetween.

4. The laminate according to claim 1, wherein the inorganic layer comprises an inorganic oxide or an inorganic nitride.

5. The laminate according to claim 1, wherein the inorganic layer comprises at least one selected from silicon oxide, silicon nitride, and aluminum oxide.

6. The laminate according to claim 1, wherein the polarizer has a thickness of 10 μm or less.

7. The laminate according to claim 1, wherein the polarizing film has a single transmittance of 30% or more and a degree of polarization of 90% or more.

8. The laminate according to claim 1, wherein the pressure-sensitive adhesive layer attached polarizing film has such a structure that the pressure-sensitive adhesive layer is placed directly on the inorganic layer, and the pressure-sensitive adhesive layer has an adhesive strength between the inorganic layer and the pressure-sensitive adhesive layer of 15 N/25 mm or more.

9. The laminate according to claim 1, wherein the pressure-sensitive adhesive layer is made from an acrylic pressure-sensitive adhesive comprising a (meth)acryl-based polymer as a base polymer.

10. The laminate according to claim 9, wherein the acrylic pressure-sensitive adhesive further contains a coupling agent.

11. The laminate according to claim 10, wherein the acrylic pressure-sensitive adhesive contains 0.001 to 5 parts by weight of the coupling agent based on 100 parts by weight of the (meth)acryl-based polymer.

12. The laminate according to claim 10, wherein the acrylic pressure-sensitive adhesive further contains a crosslinking agent.

13. The laminate according to claim 1, wherein the pressure-sensitive adhesive layer attached polarizing film has a water-vapor permeability of 0.01 g/m²·day or more and 5 g/m²·day or less as measured at 40° C. and 90% RH.

14. The laminate according to claim 1, wherein the transparent conductive layer comprises an indium tin oxide.

15. The laminate according to claim 1, wherein the indium tin oxide is amorphous indium thin oxide.

16. The laminate according to claim 1, which shows a rate of resistance change of 130% or less, wherein the rate of resistance change is a rate of change in the resistance of the transparent conductive layer between before and after storage of the laminate for 500 hours in an environment at 60° C. and 90% RH (between an initial resistance and a resistance after heating and humidification) and calculated from the formula: rate of resistance change={(the resistance after heating and humidification)/(the initial resistance)}×100.

17. An image display device comprising the laminate according to claim 1.
